(19) United States
(12) Patent Application Publication
(10) Pub. No.: US 2026/0141914 A1
(43) Pub. Date: May 21, 2026

(54) LLM-ASSISTED AUDIO SYNTHESIS FRAMEWORK

(71) Applicant: Robert Bosch GmbH, Stuttgart (DE)

(72) Inventors: Wei-Cheng Lin, Pittsburgh, PA (US); Ho-Hsiang Wu, Morrisville, NC (US); Luca Bondi, Pittsburgh, PA (US); Shabnam Ghaffarzadegan, Livermore, CA (US); Abinaya Kumar, Pittsburgh, PA (US); Samarjit Das, Wexford, PA (US)

(21) Appl. No.: 18/953,863

(22) Filed: Nov. 20, 2024

(51) Int. Cl. G10L 25/27

(52) U.S. Cl. CPC G10L 25/27

(57) ABSTRACT

Training of an audio foundation model (AFM) is performed using a dataset constructed using low-level audio property control and high-level composition planning. A plurality of digital audio compositions are generated, using a large language model (LLM) as a planner agent. The planner agent is prompted to generate composition plans defining logical combinations of foreground and background digital sounds, event occurrences within the compositions, and digital sound properties. The foreground and background digital sounds have consistent audio quality. An audio composition tool generates the plurality of digital audio compositions according to the composition plans. Descriptive text is generated for each of the digital audio compositions using a summarizer agent. The summarizer agent is implemented as an LLM, prompted to describe the digital audio compositions. The compositions and the corresponding descriptive text are combined to form audio-text pairs. An AFM is trained to interpret digital audio signals using the audio-text pairs.

### TECHNICAL FIELD

Aspects of the disclosure generally relate to a large language model (LLM)-assisted audio synthesis framework.

### BACKGROUND

Audio generative models may be capable of producing, editing, or even transforming sound effects corresponding to the given language instructions. Moreover, audio foundation models (AFMs) have been shown to be capable of translating audio content into natural language descriptions. AFMs may therefore be used for multimodal interactions in advanced audio applications.

### SUMMARY

In one or more illustrative examples, a method for training an audio foundation model (AFM) to interpret digital audio signals is provided. A plurality of digital audio compositions are generated, using a large language model (LLM) as a planner agent. The planner agent is prompted to generate composition plans defining logical combinations of foreground and background digital sounds, event occurrences within the digital audio compositions, and digital sound properties. The foreground and background digital sounds have consistent audio quality. An audio composition tool generates the plurality of digital audio compositions according to the composition plans. Descriptive text is generated for each of the plurality of digital audio compositions using a summarizer agent. The summarizer agent is implemented as an LLM, prompted to describe the digital audio compositions. The compositions and the corresponding descriptive text are combined to form audio-text pairs. An AFM is trained to interpret digital audio signals using the audio-text pairs.

In one or more illustrative examples, the method includes preparing a set of audio sources by collecting audio clips using one or more audio generative models and/or source datasets; verifying the audio quality of the audio clips using an audio quality checker to ensure consistency based on objective metrics; and storing the verified audio clips in a foreground sound bank and a background sound bank.

In one or more illustrative examples, the method includes controlling spatial properties of the foreground and background sounds and the background sounds by introducing audio spatial properties to the foreground and background sounds using impulse response (IR) parameters, wherein the IR parameters define attributes including room size, sound source location, and microphone distance; convolving the foreground and background sounds with the IR parameters to generate IR-adjusted foreground sounds and IR-adjusted background sounds; and storing the IR-adjusted foreground sounds in a foreground sound bank and the IR-adjusted background sounds in a background sound bank for use in generating the plurality of digital audio compositions.

In one or more illustrative examples, the IR parameters are descriptive of properties related to one or more of: sound reflection, energy absorption, and microphone array arrangement.

In one or more illustrative examples, the method includes using a checker agent to verify that the descriptive text generated by the summarizer agent aligns with the corresponding digital audio composition, wherein misaligned audio-text pairs are flagged for review and/or regeneration, and wherein the checker agent is implemented as a LLM receiving the descriptive text, the composition plans, and the IR parameters as inputs.

In one or more illustrative examples, the descriptive text includes question-answer pairs based on captions generated by the summarizer agent, and the AFM is trained for question answering reasoning tasks using the audio-text pairs.

In one or more illustrative examples, the descriptive text includes descriptive captions generated by the summarizer agent to describe the digital audio compositions in terms of one or more of sound events, microphone position, sound propagation, signal properties, and background scenes, and the AFM is trained for audio captioning reasoning tasks using the audio-text pairs.

In one or more illustrative examples, the signal properties include one or more of loudness level or signal-to-noise ratio (SNR).

In one or more illustrative examples, the descriptive text includes descriptive captions over time, and the AFM is trained to predict subsequent acoustic scenes based on a current digital audio composition.

In one or more illustrative examples, a system for training an audio foundation model (AFM) to interpret digital audio signals includes one or more computing devices configured to generate a plurality of digital audio compositions, including using a large language model (LLM) as a planner agent, prompted to generate composition plans defining logical combinations of foreground and background digital sounds, event occurrences within the digital audio compositions, and digital sound properties, the foreground and background digital sounds having consistent audio quality, and using an audio composition tool to generate the compositions according to the composition plans; generate descriptive text for each of the plurality of digital audio compositions using a summarizer agent, the summarizer agent being implemented as an LLM prompted to describe the digital audio compositions; combine the digital audio compositions and the corresponding descriptive text to form audio-text pairs; and train an AFM to interpret digital audio signals using the audio-text pairs.

In one or more illustrative examples, the one or more computing devices are further configured to prepare a set of audio sources by operations including to collect audio clips using one or more audio generative models and/or source datasets; verify the audio quality of the audio clips using an audio quality checker to ensure consistency based on objective metrics; and store the verified audio clips in a foreground sound bank and a background sound bank.

In one or more illustrative examples, the one or more computing devices are further configured to control spatial properties of the foreground and background sounds and the background sounds by operations including to introduce audio spatial properties to the foreground and background sounds using IR parameters, wherein the IR parameters define attributes including room size, sound source location, and microphone distance; convolve the foreground and background sounds with the IR parameters to generate IR-adjusted foreground sounds and IR-adjusted background sounds; and store the IR-adjusted foreground sounds in a foreground sound bank and the IR-adjusted background sounds in a background sound bank for use in generating the plurality of digital audio compositions.

In one or more illustrative examples, the IR parameters are descriptive of properties related to one or more of sound reflection, energy absorption, and microphone array arrangement.

In one or more illustrative examples, the one or more computing devices are further configured to use a checker agent to verify that the descriptive text generated by the summarizer agent aligns with the corresponding digital audio composition, wherein misaligned audio-text pairs are flagged for review and/or regeneration, and wherein the checker agent is implemented as a LLM receiving the descriptive text, the composition plans, and the IR parameters as inputs.

In one or more illustrative examples, the descriptive text includes question-answer pairs based on captions generated by the summarizer agent, and the AFM is trained for question answering reasoning tasks using the audio-text pairs.

In one or more illustrative examples, the descriptive text includes descriptive captions generated by the summarizer agent to describe the digital audio compositions in terms of one or more of sound events, microphone position, sound propagation, signal properties, and background scenes, and the AFM is trained for audio captioning reasoning tasks using the audio-text pairs. In one or more illustrative examples, the signal properties include one or more of loudness level or SNR.

In one or more illustrative examples, the descriptive text includes descriptive captions over time, and the AFM is trained to predict subsequent acoustic scenes based on a current digital audio composition.

In one or more illustrative examples, the system further includes one or more audio sensors configured to capture digital audio of a manufacturing system, wherein the one or more computing devices are configured to provide the captured digital audio to the AFM to perform the reasoning task on the captured digital audio.

In one or more illustrative examples, a non-transitory computer-readable medium includes instructions for training an audio foundation model (AFM) to interpret digital audio signals that, when executed by one or more computing devices, cause the one or more computing devices to perform operations including to generate a plurality of audio compositions, including using a large language model (LLM) as a planner agent, prompted to generate composition plans defining logical combinations of foreground and background digital sounds, event occurrences within the digital audio compositions, and digital sound properties, the foreground and background digital sounds having consistent audio quality, and using an audio composition tool to generate the digital audio compositions according to the composition plans; generate descriptive text for each of the plurality of audio compositions using a summarizer agent, the summarizer agent being implemented as an LLM prompted to describe the audio compositions; combine the compositions and the corresponding descriptive text to form audio-text pairs; and train an AFM to interpret digital audio signals using the audio-text pairs.

In one or more illustrative examples, the non-transitory computer-readable medium further includes instructions that, when executed by the one or more computing devices, cause the one or more computing devices to prepare a set of audio sources using operations including to: collect audio clips using one or more audio generative models and/or source datasets; verify the audio quality of the audio clips using an audio quality checker to ensure consistency based on objective metrics; and store the verified audio clips in a foreground sound bank and a background sound bank.

In one or more illustrative examples, the non-transitory computer-readable medium further includes instructions that, when executed by the one or more computing devices, cause the one or more computing devices to control spatial properties of the foreground and background sounds and the background sounds using operations including to: introduce audio spatial properties to the foreground and background sounds using IR parameters, wherein the IR parameters define attributes including room size, sound source location, and microphone distance; convolve the foreground and background sounds with the IR parameters to generate IR-adjusted foreground sounds and IR-adjusted background sounds; and store the IR-adjusted foreground sounds in a foreground sound bank and the IR-adjusted background sounds in a background sound bank for use in generating the plurality of digital audio compositions.

In one or more illustrative examples, the IR parameters are descriptive of properties related to one or more of sound reflection, energy absorption, and microphone array arrangement.

In one or more illustrative examples, the non-transitory computer-readable medium further includes instructions that, when executed by the one or more computing devices, cause the one or more computing devices to use a checker agent to verify that the descriptive text generated by the summarizer agent aligns with the corresponding digital audio composition, wherein misaligned audio-text pairs are flagged for review and/or regeneration, and wherein the checker agent is implemented as a LLM receiving the descriptive text, the composition plans, and the IR parameters as inputs.

In one or more illustrative examples, the descriptive text includes question-answer pairs based on captions generated by the summarizer agent, and the AFM is trained for question answering reasoning tasks using the audio-text pairs.

In one or more illustrative examples, the descriptive text includes descriptive captions generated by the summarizer agent to describe the digital audio compositions in terms of one or more of sound events, microphone position, sound propagation, signal properties, and background scenes, and the AFM is trained for audio captioning reasoning tasks using the audio-text pairs. In one or more illustrative examples, the signal properties include one or more of loudness level or SNR.

In one or more illustrative examples, the descriptive text includes descriptive captions over time, and the AFM is trained to predict subsequent acoustic scenes based on a current digital audio composition.

### BRIEF DESCRIPTION OF THE DRAWINGS

FIG. 1 illustrates an example process for utilizing an LLM-assisted audio synthesis framework for training and using an AFM;

FIG. 2 illustrates an example portion of the LLM-assisted audio synthesis framework for preparing audio sources;

FIG. 3 illustrates an example portion of the LLM-assisted audio synthesis framework for controlling spatial properties;

FIG. 4 illustrates an example portion of the LLM-assisted audio synthesis framework for constructing high-level audio compositions;

FIG. 5 illustrates an example portion of the LLM-assisted audio synthesis framework for determining controllable language descriptors;

FIG. 6 illustrates an example portion of the LLM-assisted audio synthesis framework for performing model training to train an AFM using the audio-text pairs;

FIG. 7 depicts a schematic diagram of an interaction between a computer-controlled machine and a control system; and

FIG. 8 illustrates an example manufacturing system implementing the AFM for use in anomaly detection.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

AFMs may be useful for various reasoning tasks. These may include, for example, performing audio question-answering (AQA) by interpreting audio signals (e.g., digital audio signals) based on user queries (e.g., Q: “What sound events are in the audio clip?”, A: “A car passing by and people talking”). However, AFMs are typically reliable only for basic semantic understanding tasks, such as reasoning or generating single sound events. Many AFMs struggle with the complexities of real-world audio environments.

For example, audio possesses unique physical properties, such as spatial information (e.g., a sound moving from left to right), localization (determining the direction of sound sources), distances (distinguishing between foreground and background sounds), and signal-to-noise ratio (SNR). Yet, these properties may be difficult to model using existing AFMs.

Beyond these fundamental audio-specific characteristics, many AFMs fall short in handling higher-level reasoning tasks. These reasoning tasks include understanding temporal causality (e.g., one event triggering another), counting events, and comprehending composite structures in audio sequences.

A challenge in performing higher-level reasoning tasks using AFMs is the scarcity of large-scale, high-quality datasets that encompass detailed, domain-specific audio information. Most audio data currently available are sourced from public platforms, which inherently lack control over and knowledge about crucial audio properties, such as the specifics of recording equipment and configurations (distance between microphone and sound sources). Moreover, these in-the-wild recordings often come with inconsistent descriptions, tags, or captions that can be tainted by subjectivity. Consequently, the uncontrollability and variability in both audio and language sources impede the progress for developing the next generation AFMs.

Aspects of the disclosure generally relate to a controllable audio synthesis framework that can simulate realistic data for use in training AFMs. This simulated data may include audio-text pairs of compositions with descriptive text describing the compositions. The compositions may be generated in logical combinations of foreground and background sounds, event occurrences, and sound properties. The foreground and background sounds may be curated to have consistent quality and spatial attributes, ensuring that the AFM is trained based on relevant features of the data. LLMs may be leveraged to generate the logical combinations and the descriptive text. Thus, the audio-language data synthesis framework combines low-level audio property control and high-level composition planning.

AFMs can be trained for various reasoning tasks using the generated dataset. These reasoning tasks may include: audio captioning and question-answering, temporal reasoning and acoustic counting, and/or long-context scenario simulation and causality forecasting. Further aspects of the disclosure are discussed in detail herein.

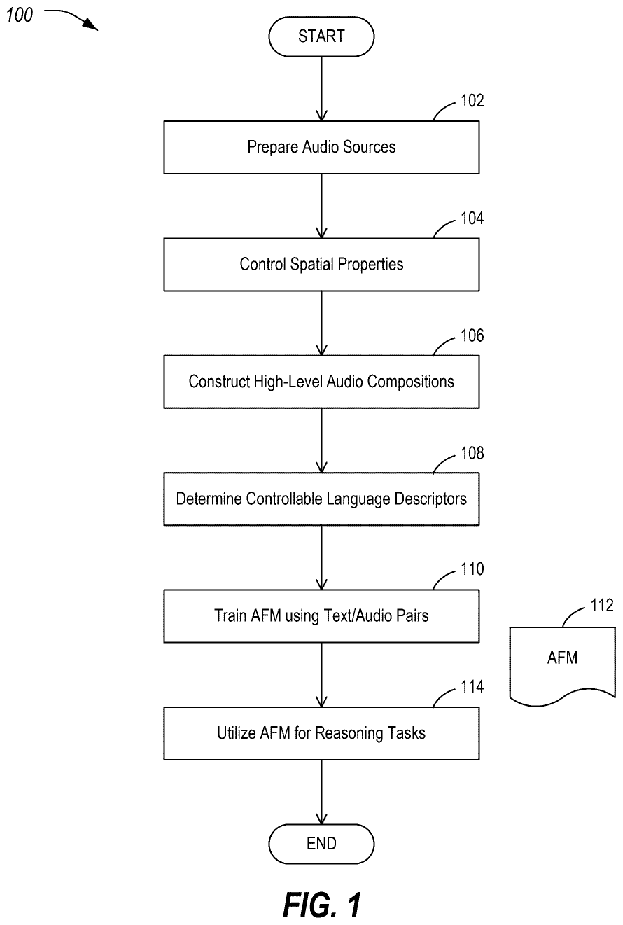

FIG. 1 illustrates an example process 100 for utilizing an LLM-assisted audio synthesis framework for training and using AFMs 112. As shown, the process 100 includes preparing audio sources 102, controlling spatial properties 104, constructing high-level audio compositions 106, determining controllable language descriptors 108, training 110 of an AFM 112, and utilizing the AFM 112 for reasoning tasks 114.

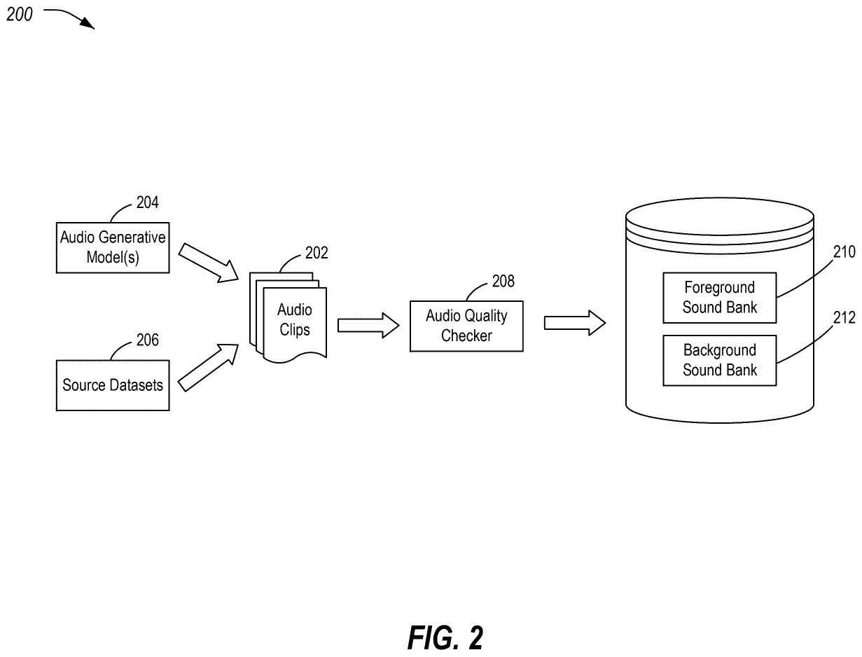

FIG. 2 illustrates an example portion 200 of the LLM-assisted audio synthesis framework for preparing audio sources 102. The preparing audio sources 102 may include operations for the collection of simple, short-term, high-quality audio clips 202. As shown, the portion 200 includes one or more audio generative models 204 and/or one or more source datasets 206. The audio generative models 204 and/or source datasets 206 are used as sources of the audio clips 202. An audio quality checker 208 verifies aspects of the audio clips 202. The verified audio clips 202 are stored into a foreground sound bank 210 and a background sound bank 212.

The audio clips 202 may include digital audio signals in the form of computer-readable sound files representing clean audio of single, clear sound events. As discussed herein, digital audio signals refers to representations of sound waves in a digital format, created by sampling and quantizing analog sound signals. Digi audio signals may be recorded with various sampling rates, quantization, optional compressions, and encodings. The audio clips 202 may be diversified to serve as the basic sound elements for creating more complex compositions. These basic sound elements may be referred to as foreground sounds and may be maintained in a foreground sound bank 210.

One source of the audio clips 202 may be audio generative models 204. The audio generative models 204 may include various pretrained models, such as AudioBox, which are capable of producing output such as simple sound effects. These audio generative models 204 may be leveraged to generate a variety of clean audio sources using straightforward prompt instructions.

Another source of the audio clips 202 may be existing clean audio source datasets 206. An example source dataset 206 is ESC50. These audio clips 202 from source datasets 206 may be incorporated to further expand the foreground sound bank 210.

The preparing audio sources 102 may also include maintaining a background sound bank 212. The background sounds audio clips 202, which may require long-term continuous audio with less emphasis on high quality, may be sourced from far-end environmental (e.g., city park, city street) or acoustic scene (e.g., domestic kitchen) sounds. These recordings may be obtained from various sources, such as security cameras (private source) or public sources such as video websites (e.g., YouTube).

An audio quality checker 208 may be executed performed on the audio clips 202 gathered from the audio generative models 204 and the source datasets 206. The audio quality checker 208 ensures consistent quality in the foreground sound bank 210 and the background sound bank 212. To do so, the audio quality checker 208 may be configured to compute various objective metrics of the audio clips 202, such as SNR, to ensure that to the audio clips 202 have matching sound quality. Audio clips 202 failing to meet the objective metrics may be discarded and not used. The result of the preparing audio sources 102 is therefore a quality-matched set of foreground and background sound clips. This quality-matching may be useful for downstream tasks. For example, if there are differences in quality, then an AFM 112 trained on the audio clips 202 may use quality as a feature instead of learning based on the content of the audio clips 202.

In one example, the audio quality checker 208 measures SNR as a ratio of the desired signal to background noise, e.g., a minimum and/or a maximum. A higher SNR indicates clearer audio, free from excessive noise. For instance, if a minimum SNR threshold is set, audio clips falling below this threshold may be flagged for exclusion or correction. Or, if a maximum SNR threshold is set (e.g., for use in scenarios such as city streets with background noise), audio clips with SNR above this threshold may be flagged for exclusion or correction. In another example, the audio quality checker 208 measures dynamic range differences between the quietest and loudest parts of an audio clip 202. This may be compared to minimum and/or maximum dynamic range. A consistent dynamic range ensures that the audio clips 202 are neither overly compressed nor excessively dynamic. In some examples, loudness normalization may be used to maintain consistent dynamic ranges. In yet another example, harmonic distortion may be measured by the audio quality checker 208 to ensure that the audio clips 202 falls within minimum and/or maximum total harmonic distortion (THD). In still another example, frequency content may be measured by the audio quality checker 208 to ensure that the audio clips 202 falls within minimum and/or maximum spectrum or balance of spectrum.

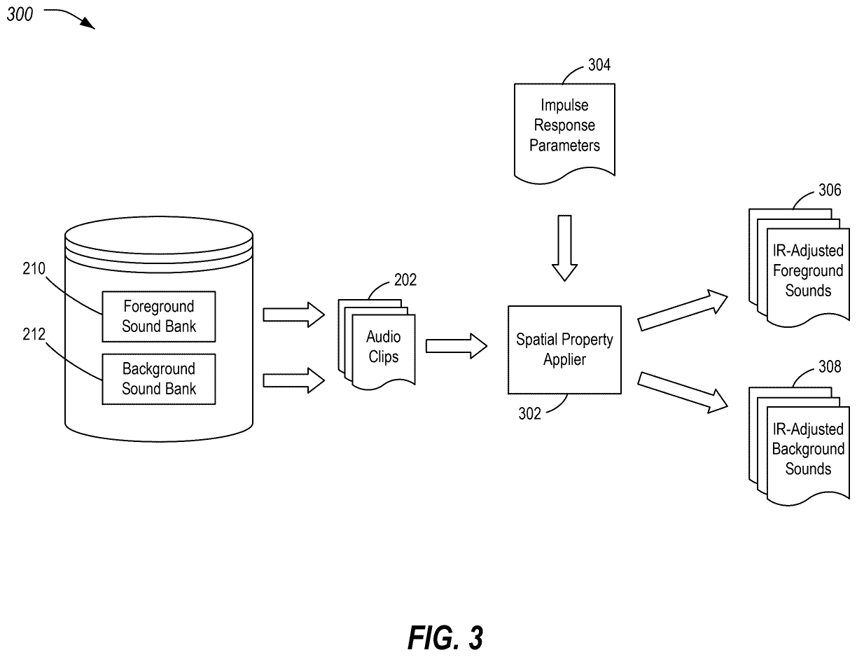

FIG. 3 illustrates an example portion 300 of the LLM-assisted audio synthesis framework for controlling spatial properties 104. As shown, audio clips 202 from the foreground sound bank 210 and the background sound bank 212 may be processed by a spatial property applier 302 to control introduction of audio spatial properties to the audio clips 202 by using impulse response (IR) parameters 304. The result of the spatial property applier 302 may be IR-adjusted foreground sounds 306 and/or IR-adjusted background sounds 308.

The spatial property applier 302 may be used to introduce audio spatial properties. This may be done in order to simulate a desired IR for the audio clips 202. Example IRs may include outdoors, in an echo-y room with hard surfaces, etc. The IR may be applied to the audio clips 202 by manipulation of common audio spatial attributes of the audio clips 202.

The specific IR to apply may be defined by the impulse response parameters 304. These impulse response parameters 304 may be provided as an input to the spatial property applier 302. The specific attributes specified by the impulse response parameters 304 may include one or more of: room size (indoor), reflection/propagation, energy absorption (transmission medium), sound source location and direction, microphone distances, and microphone array arrangements.

In an example, the controlled impulse response parameters 304 may be provided in a spatial configuration file (e.g., in JavaScript Object Notation (JSON) as a file titled spatial_config.json) to inform the spatial property applier 302 how to generate the corresponding IRs. Then, the audio clips 202 are convolved with these IRs to apply spatial sound effects. In an example, the introduction of audio spatial properties may be performed using the open-source Pyroomacoustics library. Pyroomacoustics is a package for audio signal processing for indoor applications that creates artificial room impulse responses between sources and microphones. For audio clips 202 that are from the foreground sound bank 210, the result of the introduction of the audio spatial properties is IR-adjusted foreground sounds 306. For audio clips 202 that are from the background sound bank 212, the result of the introduction of the audio spatial properties is IR-adjusted background sounds 308.

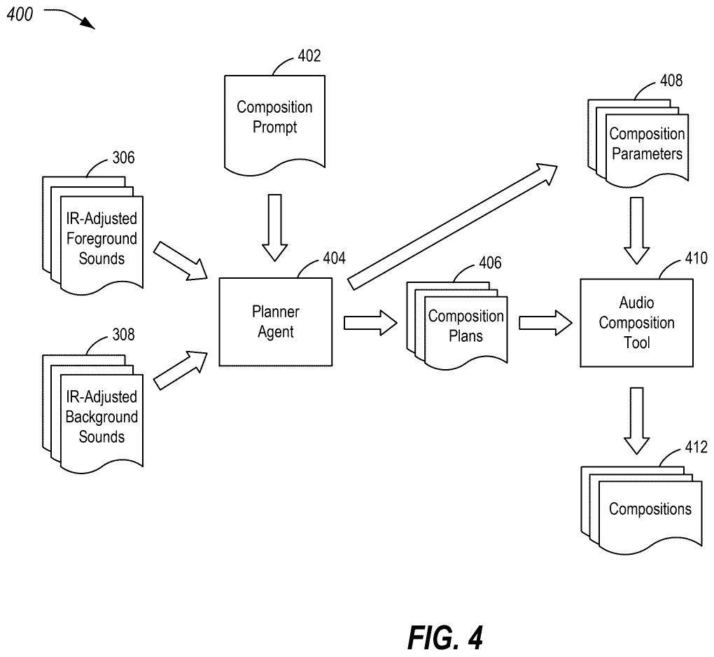

FIG. 4 illustrates an example portion 400 of the LLM-assisted audio synthesis framework for constructing high-level audio compositions 106. As shown, the IR-adjusted foreground sounds 306 and IR-adjusted background sounds 308 may be applied to a planner agent 404. Using these IR-adjusted foreground sounds 306, IR-adjusted background sounds 308, and a composition prompt 402, the planner agent 404 determines composition plans 406 for the assembly of the audio clips 202 of the IR-adjusted foreground sounds 306 and IR-adjusted background sounds 308. These composition plans 406 may be applied to an audio composition tool 410 to generate compositions 412 of the IR-adjusted foreground sounds 306 and IR-adjusted background sounds 308.

The planner agent 404 may be any of various LLMs, such as GPT-4, Llama, Claude, etc. LLMs may be used for various high-level reasoning tasks 114 and are considered powerful engines of commonsense knowledge. The planner agent 404 may receive a composition prompt 402, which may include instructions instructing the planner agent 404 to determine composition plans 406 for the creation of compositions 412. The composition plans 406 may define how to combine the IR-adjusted foreground sounds 306 and IR-adjusted background sounds 308 in a logical manner and/or using event class labels from existing corpora.

Composition parameters 408 may specify other metadata information descriptive of the desired compositions 412. The composition parameters 408 may include, as some non-limiting examples, SNR adjustments for the audio clips 202 to be combined (e.g., in dB), event frequencies (e.g., occurrences of specific events, e.g., playback of specific audio clips 202), foreground/background sound combination mechanisms, and timespan of the desired results (e.g., event duration, length or rate) of each sounding event and/or of the overall composition 412. These parameters may be extracted and listed as synthesis configuration JSON files (e.g., synth_config.json) to direct the audio composition tool 410 to generate final audio compositions 412 according to the given instructions.

The planner agent 404 may be used to fill in in the composition parameters 408, using commonsense knowledge to compose reasonable sounding event combinations for realistic data curation. For instance, the planner agent 404 may prevent unrealistic combinations, such as associating a background city park scenario with a foreground microwave event, unlike traditional synthesis frameworks that may perform uncontrollable random match-ups of audio clips 202.

The audio composition tool 410 may be used to synthesize the compositions 412 from the audio clips 202 and the various composition parameters 408. In an example, the SCAPER package may be used as the audio composition tool 410.

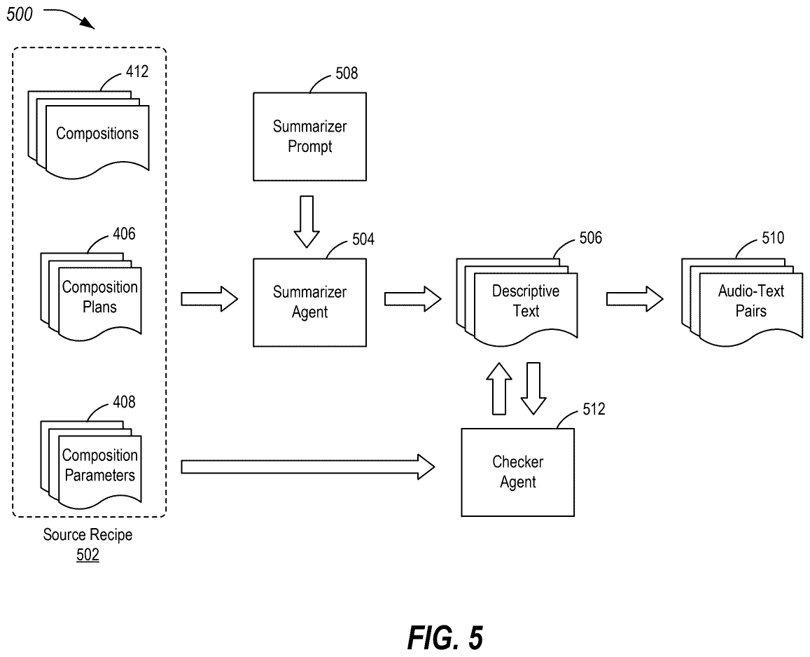

FIG. 5 illustrates an example portion 500 of the LLM-assisted audio synthesis framework for determining controllable language descriptors 108. Regarding determining controllable language descriptors 108, a source recipe 502 of various information is fed into a summarizer agent 504 configured to generate descriptive text 506 descriptive of the compositions 412. A summarizer prompt 508 may be used to instruct the summarizer agent 504 with respect to the type of descriptive text 506 to generate. Descriptive text 506 may be generated for each of the compositions 412, such that combinations of the descriptive text 506 and compositions 412 may be compiled together as audio-text pairs 510. To minimize the potential for hallucinations in the descriptive text 506, an additional checker agent 512 may be used to cross-verify that the descriptive text 506 is aligned in content with the given source recipe 502.

The source recipe 502 may include various information such as: the composition plans 406 determined by the planner agent 404 (e.g., which foreground events included in the audio clips 202 of the IR-adjusted foreground sounds 306 are associated with which background audio clips 202 of the IR-adjusted background sounds 308), the filled controlled impulse response parameters 304, and the composition parameters 408.

The summarizer agent 504, as with the planner agent 404 may be any of various LLMs. In some examples, the summarizer agent 504 may be the same LLM as the planner agent 404 with a different prompt (e.g., the summarizer prompt 508), while in other cases the summarizer agent 504 may be a different LLM. Using the full source recipe 502 corresponding to the synthesized audio compositions 412, the summarizer agent 504 may generate natural language descriptive text 506 that accurately reflect the acoustic characteristics in each synthesized audio composition 412.

The summarizer prompt 508 may include instructions to the summarizer agent 504 with respect to the type of descriptive text 506 to generate. In one example, the summarizer prompt 508 may direct the summarizer agent 504 to generate captions for the compositions 412. In another example, the summarizer prompt 508 may direct the summarizer agent 504 to generate question-and-answer pairs for the compositions 412. The descriptive text 506 may be generated for each of the compositions 412, such that the combination of the descriptive text 506 and the composition 412 that is described by the descriptive text 506 are combined as audio-text pairs 510. The audio-text pairs 510 may accordingly serve as a train data set for the training 110 of AFMs 112.

The checker agent 512, as with the planner agent 404 and the summarizer agent 504 may be any of various LLMs. In some examples, the checker agent 512 may be the same LLM as the planner agent 404 or checker agent 512 (potentially with a different prompt), while in other cases the checker agent 512 may be a different LLM. In some examples a different LLM is preferred, such that potential deficiencies in the summarizer agent 504 may be addressed by the checker agent 512.

If the checker agent 512 determines that the descriptive text 506 is not descriptive of its respective composition 412, then the checker agent 512 may flag that potential audio-text pair 510 for review, direct the composition 412 and/or the descriptive text 506 to be regenerated, and/or prevent that potential audio-text pair 510 from being included in the audio-text pairs 510.

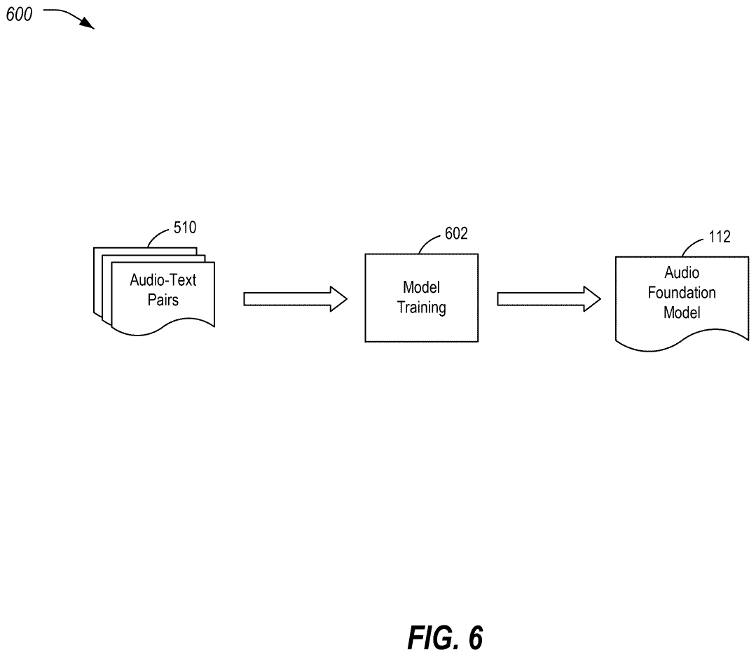

FIG. 6 illustrates an example portion 600 of the LLM-assisted audio synthesis framework for performing model training 602 to train an AFM 112 using the audio-text pairs 510. For example, the summarizer agent 504 may describe the audio compositions in terms of one or more of sound events, microphone position, sound propagation, signal properties, and background scenes, where the AFM 112 may be trained to interpret digital audio signals for audio captioning reasoning tasks using the audio-text pairs 510. In one or more illustrative examples, the signal properties include one or more of loudness level or signal-to-noise ratio (SNR).

In one example, the model training 602 may include training 110 for audio captioning and question-answering. In such an example, the framework may be used to generate audio-text pairs 510 including captions and question-answer sets for each of the compositions 412. These elements of information may be useful for facilitating training 110 of advanced AFMs 112 such as contrastive language-audio pretraining (CLAP) and AQA models.

The following caption example is of descriptive text 506 from the summarizer agent 504. This caption demonstrates that the planner agent 404 picks up the speech as foreground events while under an office background environment with some rotary phone sounds, which correctly follows the commonsense rationale of the sound compositions 412:

Caption = “A 20-second audio recording from a far-end microphone
capturing speech amidst the noisy background of an office with a classic
rotary phone being hung up and picked up four times, with the speech
becoming prominent from 4.5 seconds until the end.”

Detailed audio properties controlled by controlled impulse response parameters 304 and the composition parameters 408 may also be accurately incorporated in the caption descriptive text 506, such as that the far-end microphone indicates the microphone location, noisy background shows it is a simulated low-SNR recording, and the four times identifies the quantity of the phone event audio clip 202 in the composition 412.

In addition, AQA pairs may be curated by prompting an LLM based on the caption descriptive text 506. For instance:

| Questions | Answers |
|---|---|
| What is the foreground sound? | speech |
| What is the background scene? | office |
| What is the microphone distance? | far-end |
| What is the recording SNR? | low |
| How many times does the phone has been picked up? | four times |

Using these question/answer descriptive texts 506, and the compositions 412 as audio-text pairs 510, the model training 602 may be performed to teach an AFM 112 to perform question answering based on audio files. Such a model, in inference mode, may receive an audio clip 202 and a question about the audio clip 202, and may generate an answer to the question.

In another example, the model training 602 may include training 110 to interpret digital audio signals for temporal reasoning and acoustic counting. Again using the framework, compositions 412 including soundscapes may be curated that follow a desired event order, occurrence timing, and frequency or count of occurrences, thereby enhancing the complexity of AQA and audio captioning tasks. For example, the following caption can generate complex questions incorporating temporal concepts:

Caption = “At the beginning, continuous footsteps and dog panting sounds
are heard, accompanied by distant traffic noise. Birds chirp intermittently
for five times, and after 10 seconds, the dog barks three times. Following
by children playing sounds.”

Using this caption, AQA pairs may be curated by prompting an LLM based on the caption descriptive text 506. For instance:

| Questions | Answers |
|---|---|
| What is the sound happened before children | dog barking |
| playing? | |
| What sounds might happen simultaneity? | footsteps, dog panting, |
| | traffic noise |
| Does the bird chirping sound happen after | no, it's before |
| the dog barking event? | three times |
| How many times does the dog barks? | five times |
| How many times does the bird chirps? | city park |
| What might be the acoustic scene? | |

Thus, performing the model training 602 of the AFM 112 using these question/answer descriptive texts 506, and the compositions 412 as audio-text pairs 510 enables the AFM 112 to tackle higher complexity tasks, such as temporal reasoning or acoustic scene understanding.

In yet another example, the model training 602 may include training 110 to interpret digital audio signals for long-context scenario simulation and causality forecasting. In such an application of the framework, the reasoning capability of the AFM 112 is to forecast upcoming causality scenarios based on an understanding of a current acoustic environment. Similarly, the synthesis framework may be used to curate long-context acoustic scenarios following the desired causality. Following up on the previous example, a causality of the next scene could be:

Current: “At the beginning, continuous footsteps and dog panting sounds
are heard, accompanied by distant traffic noise. Birds chirp intermittently
for five times, and after 10 seconds, the dog barks three times. Following
by children playing sounds.”
Next: “People shouting to the dog and the frightened children start
screaming and crying.”

Accordingly, the synthesis based on the causality instructions can be incorporated into a next acoustic scene prediction task to allow the AFMs 112 to enforce the capability.

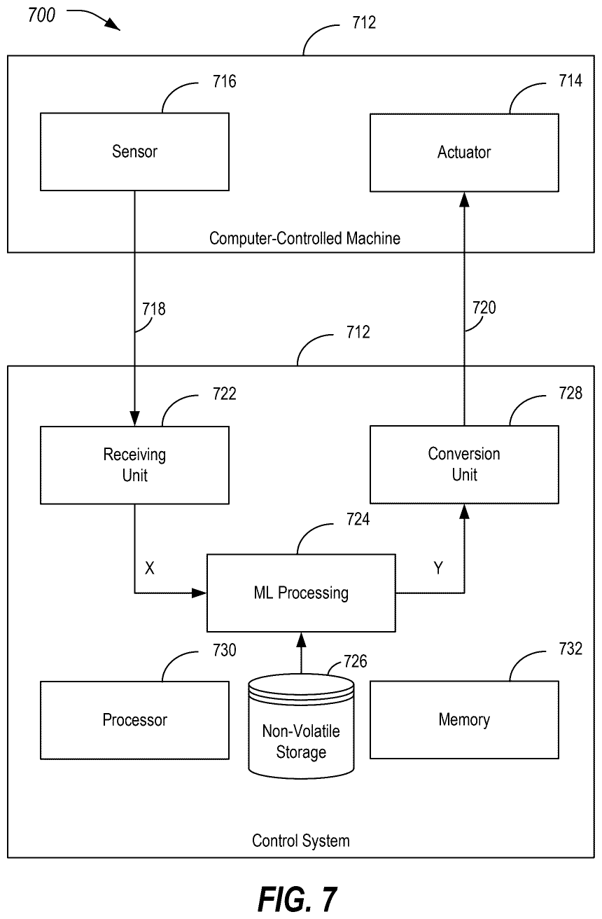

FIG. 7 depicts a schematic diagram of an interaction between a computer-controlled machine 702 and a control system 712. The computer-controlled machine 702 may implement aspects of the AFM 112 trained as discussed herein using the framework to interpret digital audio signals to perform various reasoning tasks 114.

Referring to FIG. 7, and with reference to FIGS. 1-6, the approaches discussed herein may be performed in the context of such a computer-controlled machine 702 and control system 712. The computer-controlled machine 702 includes actuator 714 and sensor 716. Actuator 714 may include one or more actuators and sensor 716 may include one or more sensors. Sensor 716 is configured to sense a condition of computer-controlled machine 702. Sensor 716 may be configured to encode the sensed condition into sensor signals 718 and to transmit sensor signals 718 to control system 712. Non-limiting examples of sensor 716 include microphones, accelerometers, and the like. In one embodiment, sensor 716 is an audio sensor configured to sense audio data of an environment proximate to computer-controlled machine 702.

Control system 712 is configured to receive sensor signals 718 from computer-controlled machine 702. As set forth below, control system 712 may be further configured to compute actuator control commands 720 depending on the sensor signals 718 and to transmit actuator control commands 720 to actuator 714 of computer-controlled machine 702.

As shown in FIG. 7, control system 712 includes receiving unit 722. Receiving unit 722 may be configured to receive sensor signals 718 from sensor 716 and to transform sensor signals 718 into input signals X. In an alternative embodiment, sensor signals 718 are received directly as input signals X without receiving unit 722. Each input signal x may be a portion of each sensor signal 718. Receiving unit 722 may be configured to process each sensor signal 718 to product each input signal X. Input signal X may include data corresponding to sound recorded by sensor 716.

Control system 712 includes machine learning (ML) processing 724. ML processing 724 may be configured to learn, classify, infer, generate, etc. using one or more models such as those described in detail above. In an example, ML processing 724 is configured to determine output signals Y from input signals X. Each output signal Y includes information that assigns one or more labels to each input signal X. ML processing 724 may transmit output signals Y to conversion unit 728. Conversion unit 728 is configured to convert output signals Y into actuator control commands 720. Control system 712 is configured to transmit actuator control commands 720 to actuator 714, which is configured to actuate computer-controlled machine 702 in response to actuator control commands 720. In another embodiment, actuator 714 is configured to actuate computer-controlled machine 702 based directly on output signals Y.

Upon receipt of actuator control commands 720 by actuator 714, actuator 714 is configured to execute an action corresponding to the related actuator control command 720. Actuator 714 may include a control logic configured to transform actuator control commands 720 into a second actuator control command 720, which is utilized to control actuator 714. In one or more embodiments, actuator control commands 720 may be utilized to control a display instead of or in addition to an actuator 714.

In another embodiment, control system 712 includes sensor 716 instead of or in addition to computer-controlled machine 702 including sensor 716. Control system 712 may also include actuator 714 instead of or in addition to computer-controlled machine 702 including actuator 714.

As shown in FIG. 7, control system 712 also includes processor 730 and memory 732. Processor 730 may include one or more processors. Memory 732 may include one or more memory devices.

Non-volatile storage 726 may include one or more persistent data storage devices such as a hard drive, optical drive, tape drive, non-volatile solid-state device, cloud storage or any other device capable of persistently storing information. Processor 730 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 732. Memory 732 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information.

Processor 730 may be configured to read into memory 732 and execute computer-executable instructions residing in non-volatile storage 726 and embodying one or more ML algorithms and/or methodologies of one or more embodiments. Non-volatile storage 726 may include one or more operating systems and applications. Non-volatile storage 726 may store compiled and/or interpreted from computer programs created using a variety of programming languages and/or technologies, including, without limitation, and either alone or in combination, Java, C, C++, C#, Objective C, Fortran, Pascal, JavaScript, Python, and/or Perl.

Upon execution by processor 730, the computer-executable instructions of non-volatile storage 726 may cause control system 712 to implement one or more of the ML algorithms and/or methodologies as disclosed herein. Non-volatile storage 726 may also include ML data (including data parameters) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, read-only memory (ROM), erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

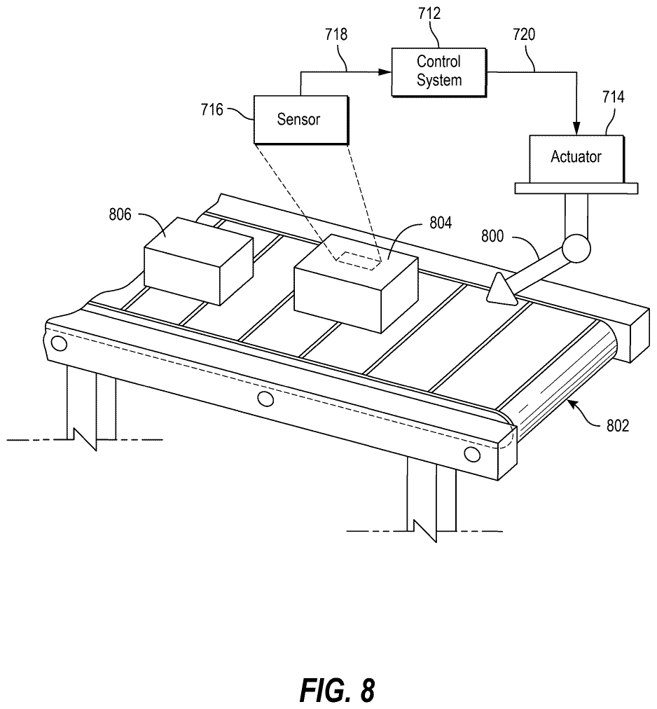

FIG. 8 illustrates an example manufacturing system 800 implementing the AFM 112 for use in anomaly detection. The system 800 may be configured to control a manufacturing machine 802, such as a punch cutter, a cutter or a gun drill, etc., such as part of a production line.

The system 800 may be configured to control an actuator 714, which is configured to control the manufacturing machine 802. A sensor 716 of the system 800 may be configured to capture one or more properties of a manufactured product 804. ML processing 724 may be configured to determine a state of the manufactured product 804 from one or more of the captured properties. An actuator 714 may be configured to control the system 800 (e.g., the manufacturing machine 802) depending on the determined state of the manufactured product 804 for a subsequent manufacturing step of the manufactured product 804. In particular, the actuator 714 may be configured to control functions of system 800 (e.g., the manufacturing machine 802) on subsequent manufactured product 806 of the system 800 (e.g., the manufacturing machine 802) depending on the determined state of the manufactured product 804.

For example, the system 800 may utilize the AFM 112, trained as discussed herein using the framework, to explain reasons for potential issues in the manufacturing system 800. This may occur based on unusual sounds collected from the sensors 716. In another example, the system 800 may utilize the AFM 112 to predict next predicted outcomes that should be addressed based on the sounds collected from the sensors 716, especially if the next actions may involve a manufacturing issue. In yet another example, the AFM 112 may be used to answer questions from a user about the sounds that are captured by the sensors 716.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, compact discs (CDs), RAM devices, and other magnetic and optical media. The processes, methods, or algorithms can also be implemented in a software executable object. Alternatively, the processes, methods, or algorithms can be embodied in whole or in part using suitable hardware components, such as ASICs, FPGAs, state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, life cycle, marketability, appearance, packaging, size, serviceability, weight, manufacturability, case of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method for training an audio foundation model (AFM) to interpret digital audio signals, comprising:
generating a plurality of digital audio compositions, including using a large language model (LLM) as a planner agent, prompted to generate composition plans defining logical combinations of foreground and background digital sounds, event occurrences within the digital audio compositions, and digital sound properties, the foreground and background digital sounds having consistent audio quality, and using an audio composition tool to generate the compositions according to the composition plans;
generating descriptive text for each of the plurality of digital audio compositions using a summarizer agent, the summarizer agent being implemented as an LLM prompted to describe the digital audio compositions;
combining the digital audio compositions and the corresponding descriptive text to form audio-text pairs; and
training an AFM to interpret digital audio signals using the audio-text pairs.

2. The method of claim 1, further comprising preparing a set of audio sources by:
collecting audio clips using one or more audio generative models and/or source datasets;
verifying the audio quality of the audio clips using an audio quality checker to ensure consistency based on objective metrics; and
storing the verified audio clips in a foreground sound bank and a background sound bank.

3. The method of claim 1, further comprising controlling spatial properties of the foreground and background sounds and the background sounds by:
introducing audio spatial properties to the foreground and background sounds using impulse response (IR) parameters, wherein the IR parameters define attributes including room size, sound source location, and microphone distance;
convolving the foreground and background sounds with the IR parameters to generate IR-adjusted foreground sounds and IR-adjusted background sounds; and
storing the IR-adjusted foreground sounds in a foreground sound bank and the IR-adjusted background sounds in a background sound bank for use in generating the plurality of digital audio compositions.

4. The method of claim 3, wherein the IR parameters are descriptive of properties related to one or more of: sound reflection, energy absorption, and microphone array arrangement.

5. The method of claim 3, further comprising:
using a checker agent to verify that the descriptive text generated by the summarizer agent aligns with the corresponding digital audio composition,
wherein misaligned audio-text pairs are flagged for review and/or regeneration, and
wherein the checker agent is implemented as a LLM receiving the descriptive text, the composition plans, and the IR parameters as inputs.

6. The method of claim 1, wherein the descriptive text includes question-answer pairs based on captions generated by the summarizer agent, and the AFM is trained for question answering reasoning tasks using the audio-text pairs.

7. The method of claim 1, wherein the descriptive text includes descriptive captions generated by the summarizer agent to describe the digital audio compositions in terms of one or more of sound events, microphone position, sound propagation, signal properties, and background scenes, and the AFM is trained for audio captioning reasoning tasks using the audio-text pairs.

8. The method of claim 7, wherein the signal properties include one or more of loudness level or signal-to-noise ratio (SNR).

9. The method of claim 1, wherein the descriptive text includes descriptive captions over time, and the AFM is trained to predict subsequent acoustic scenes based on a current digital audio composition.

10. A system for training an audio foundation model (AFM) to interpret digital audio signals, comprising:
one or more computing devices configured to:
generate a plurality of digital audio compositions, including using a large language model (LLM) as a planner agent, prompted to generate composition plans defining logical combinations of foreground and background digital sounds, event occurrences within the digital audio compositions, and digital sound properties, the foreground and background digital sounds having consistent audio quality, and using an audio composition tool to generate the digital audio compositions according to the composition plans;
generate descriptive text for each of the plurality of digital audio compositions using a summarizer agent, the summarizer agent being implemented as an LLM prompted to describe the digital audio compositions;
combine the digital audio compositions and the corresponding descriptive text to form audio-text pairs; and
train an AFM to interpret digital audio signals using the audio-text pairs.

11. The system of claim 10, wherein the one or more computing devices are further configured to prepare a set of audio sources by operations including to:
collect audio clips using one or more audio generative models and/or source datasets;
verify the audio quality of the audio clips using an audio quality checker to ensure consistency based on objective metrics; and
store the verified audio clips in a foreground sound bank and a background sound bank.

12. The system of claim 10, wherein the one or more computing devices are further configured to control spatial properties of the foreground and background sounds and the background sounds by operations including to:
introduce audio spatial properties to the foreground and background sounds using IR parameters, wherein the IR parameters define attributes including room size, sound source location, and microphone distance;
convolve the foreground and background sounds with the IR parameters to generate IR-adjusted foreground sounds and IR-adjusted background sounds; and
store the IR-adjusted foreground sounds in a foreground sound bank and the IR-adjusted background sounds in a background sound bank for use in generating the plurality of digital audio compositions.

13. The system of claim 12, wherein the IR parameters are descriptive of properties related to one or more of: sound reflection, energy absorption, and microphone array arrangement.

14. The system of claim 12, wherein the one or more computing devices are further configured to:
use a checker agent to verify that the descriptive text generated by the summarizer agent aligns with the corresponding digital audio composition,
wherein misaligned audio-text pairs are flagged for review and/or regeneration, and
wherein the checker agent is implemented as a LLM receiving the descriptive text, the composition plans, and the IR parameters as inputs.

15. The system of claim 10, wherein the descriptive text includes question-answer pairs based on captions generated by the summarizer agent, and the AFM is trained for question answering reasoning tasks using the audio-text pairs.

16. The system of claim 10, wherein the descriptive text includes descriptive captions generated by the summarizer agent to describe the digital audio compositions in terms of one or more of sound events, microphone position, sound propagation, signal properties, and background scenes, and the AFM is trained for audio captioning reasoning tasks using the audio-text pairs.

17. The system of claim 16, wherein the signal properties include one or more of loudness level or SNR.

18. The system of claim 10, wherein the descriptive text includes descriptive captions over time, and the AFM is trained to predict subsequent acoustic scenes based on a current digital audio composition.

19. The system of claim 10, further comprising one or more audio sensors configured to capture digital audio of a manufacturing system, wherein the one or more computing devices are configured to provide the captured digital audio to the AFM to perform the reasoning task on the captured digital audio.

20. A non-transitory computer-readable medium comprising instructions for training an audio foundation model (AFM) to interpret digital audio signals that, when executed by one or more computing devices, cause the one or more computing devices to perform operations including to:
generate a plurality of digital audio compositions, including using a large language model (LLM) as a planner agent, prompted to generate composition plans defining logical combinations of foreground and background digital sounds, event occurrences within the digital audio compositions, and digital sound properties, the foreground and background digital sounds having consistent audio quality, and using an audio composition tool to generate the digital audio compositions according to the composition plans;
generate descriptive text for each of the plurality of digital audio compositions using a summarizer agent, the summarizer agent being implemented as an LLM prompted to describe the digital audio compositions;
combine the compositions and the corresponding descriptive text to form audio-text pairs; and
train an AFM to interpret digital audio signals using the audio-text pairs.

21. The non-transitory computer-readable medium of claim 20, further comprising instructions that, when executed by the one or more computing devices, cause the one or more computing devices to prepare a set of audio sources using operations including to:
collect audio clips using one or more audio generative models and/or source datasets;
verify the audio quality of the audio clips using an audio quality checker to ensure consistency based on objective metrics; and
store the verified audio clips in a foreground sound bank and a background sound bank.

22. The non-transitory computer-readable medium of claim 20, further comprising instructions that, when executed by the one or more computing devices, cause the one or more computing devices to control spatial properties of the foreground and background sounds and the background sounds using operations including to:
introduce audio spatial properties to the foreground and background sounds using IR parameters, wherein the IR parameters define attributes including room size, sound source location, and microphone distance;
convolve the foreground and background sounds with the IR parameters to generate IR-adjusted foreground sounds and IR-adjusted background sounds; and
store the IR-adjusted foreground sounds in a foreground sound bank and the IR-adjusted background sounds in a background sound bank for use in generating the plurality of digital audio compositions.

23. The non-transitory computer-readable medium of claim 22, wherein the IR parameters are descriptive of properties related to one or more of: sound reflection, energy absorption, and microphone array arrangement.

24. The non-transitory computer-readable medium of claim 22, further comprising instructions that, when executed by the one or more computing devices, cause the one or more computing devices to:
use a checker agent to verify that the descriptive text generated by the summarizer agent aligns with the corresponding digital audio composition,
wherein misaligned audio-text pairs are flagged for review and/or regeneration, and
wherein the checker agent is implemented as a LLM receiving the descriptive text, the composition plans, and the IR parameters as inputs.

25. The non-transitory computer-readable medium of claim 20, wherein the descriptive text includes question-answer pairs based on captions generated by the summarizer agent, and the AFM is trained for question answering reasoning tasks using the audio-text pairs.

26. The non-transitory computer-readable medium of claim 20, wherein the descriptive text includes descriptive captions generated by the summarizer agent to describe the digital audio compositions in terms of one or more of sound events, microphone position, sound propagation, signal properties, and background scenes, and the AFM is trained for audio captioning reasoning tasks using the audio-text pairs.

27. The non-transitory computer-readable medium of claim 26, wherein the signal properties include one or more of loudness level or SNR.

28. The non-transitory computer-readable medium of claim 20, wherein the descriptive text includes descriptive captions over time, and the AFM is trained to predict subsequent acoustic scenes based on a current digital audio composition.
